(19) United States
(12) Patent Application Publication
(10) Pub. No.: US 2025/0019137 A1
(43) Pub. Date: Jan. 16, 2025

(54) LID DEVICE FOR COVERING A GLASS

(71) Applicants: Elnora Johnson, Brookline, MA (US); Antel Rogers, Brookline, PA (US)

(72) Inventors: Elnora Johnson, Brookline, MA (US); Antel Rogers, Brookline, PA (US)

(21) Appl. No.: 18/769,950

(22) Filed: Jul. 11, 2024

Related U.S. Application Data
(60) Provisional application No. 63/513,231, filed on Jul. 12, 2023.

(51) Int. Cl. B65D 51/24; A47G 19/22; B65D 43/02; B65D 55/02; G07C 9/00

(52) U.S. Cl. CPC B65D 51/24; A47G 19/22; B65D 43/0202; B65D 55/028; G07C 9/00563; B65D 2211/00; B65D 2543/00092

(57) ABSTRACT

A lid device that can securely cover a glass of beverage, preventing intentional contamination of the contents by unauthorized individuals. The device fits tightly over the glass by creating a partial vacuum inside. It also includes a fingerprint scanner for user authorization. Upon successful fingerprint verification, the lid can be easily released from the glass without applying undue force.

### CROSS-REFERENCE TO RELATED APPLICATIONS

This application claims priority from a U.S. Provisional Patent Appl. No. 63/513,231, filed on Jul. 12, 2023, which is incorporated herein by reference in its entirety.

### FIELD OF INVENTION

The present invention relates to a lid for covering a glass, and more particularly, the present invention relates to an electronic lid device that can be secured by suction to cover a glass and includes a fingerprint scanner, an alarm and LED light.

### BACKGROUND

It's common for people to drink at public places like bars, parties, beaches, clubs, and concerts. They enjoy alcohol, juices, cocktails, and other beverages. While drinking, they often chat with others. Many times, people leave their drinks on a table and go to dance, socialize, or have a conversation. Drinks are usually served in glasses, and there is always a risk of something falling into the glass. To prevent accidental contamination from dust, insects, and other things, glass covers are used to temporarily cover the glasses.

Glass covers can prevent objects from falling into a glass, but they cannot stop someone from intentionally contaminating a beverage. Individuals with malicious intentions may attempt to tamper with a drink. For instance, they could secretly drop a drug into an unattended glass of beverage in order to intoxicate the person drinking from it. This could then lead to further harm, such as sexual abuse of the intoxicated person.

A lid that can be securely fit onto a glass and cannot be removed by a miscreant is therefore appreciated.

It is to be noted that the terms “beverage” and “drink” are interchangeably used herein and refer to any liquid that can be served in a glass for drinking. Also, the term glasses include any container with a bowl having a flat top rim, such as a cup.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a lid device for glasses that can cover a glass and can be removed only by an authorized person.

Another object of the present invention is that the lid device can prevent tampering with a drink in the glass by any miscreant.

Another object of the present invention is that the lid device is easy to use.

Still, another object of the present invention is that the lid device can be used with glasses of different sizes.

A further object of the present invention is that the lid device is portable.

Yet another object of the present invention is that the lid device can trigger an alarm/LED light upon detecting any tampering with the lid device covering the glass

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a top view of the lid device, according to an exemplary embodiment of the present invention.

FIG. 2 shows a side view of the lid device, according to an exemplary embodiment of the present invention.

FIG. 3 is a perspective view of a lid device, secured to a glass, according to an exemplary embodiment of the present invention.

FIG. 4 shows a side view of the lid device and the glass, according to an exemplary embodiment of the present invention.

FIG. 5 shows the lid device mounted to a different glass, according to an exemplary embodiment of the present invention.

FIG. 6 is a block diagram showing the architecture of the lid device, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

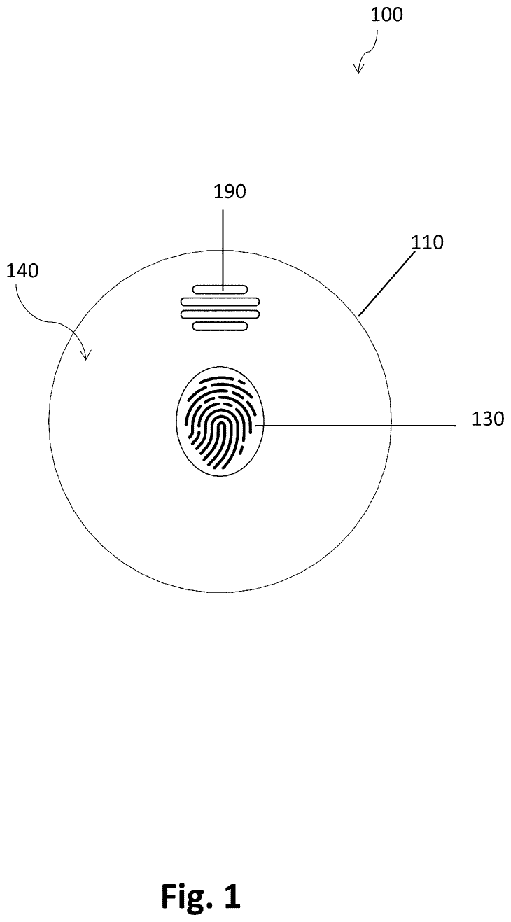

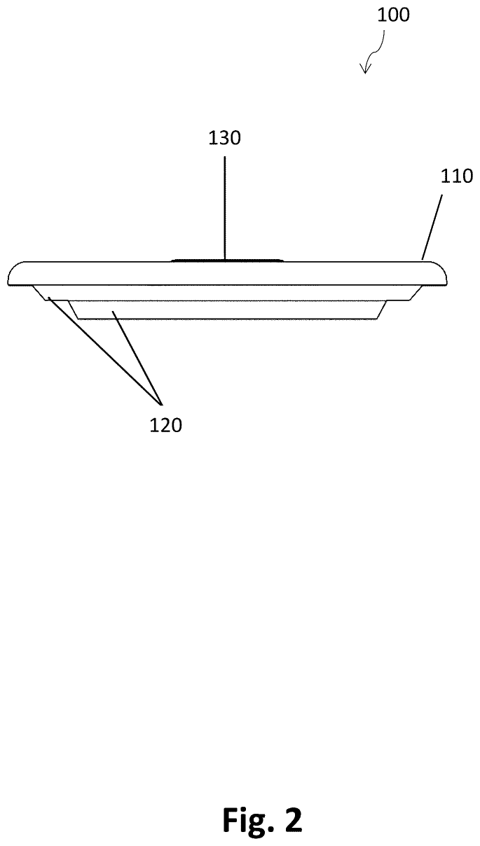

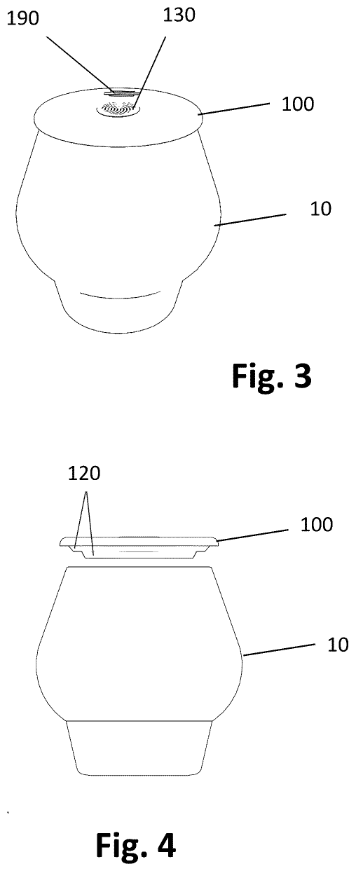

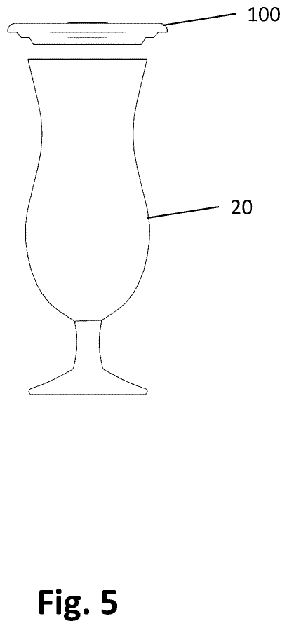

The described invention pertains to a lid device for securely covering glass. The user of the lid device can only remove the lid device. The term “user” herein refers to any person who uses the disclosed device and is registered to unlock the device. Refer to FIG. 1 which shows a top view of the disclosed lid device 100 and FIG. 2 which shows a side view of the lid device 100. The lid device 100 includes a housing 110 that encases different components. The housing includes a top, a bottom, and a side wall. The bottom of the housing may engage with a rim of the glass over which the device is placed for securing the same. Preferably, the side wall 120 of the housing can be stepped inwards as shown in FIG. 2. And a step can engage with the rim of the glass instead of the bottom. The step or the bottom of the housing can sealably engage with the rim of the glass. For sealing, a layer of soft material that can grip the rim of the glass can be disposed over the stepped side wall and/or the bottom of the housing. Also, the material of the layer may be compatible for use with food items. For example, a silicon layer can be applied to the steps and/or the bottom of the housing.

In certain implementations, the number of inward steps of the sidewall may vary without departing from the scope of the present invention. The multiple steps allow the disclosed device to be used with different sizes of glasses. For example, a step of the sidewall is of a different diameter than its adjacent steps. The step at the bottom can fit over a glass of lower size, while the upper step can fit over a larger size glass.

In certain implementations, the housing can include a single step side wall. In certain implementations, the side wall can include two inward steps. In certain implementations, the sidewall may include three steps. In certain implementations, the sidewall may include four steps. In certain implementations, the sidewall may include three or more steps.

The device may also include a fingerprint scanner 130 mounted to the top plate 140 of the housing. A user can place his finger on the top plate or portion of the top plate for a fingerprint scan. A battery 150 can also be encased within the housing for powering different components.

The lid device may also include a suction motor 160 that can be encased within the housing. The suction motor allows for partial suctioning of the air from the glass, thus creating a partial vacuum in the glass. The lid device remains secured to the glass through this partial vacuum. The lid device cannot be easily removed from the glass by force. Only releasing the suction may result in the freeing of the lid device and then the lid device can be removed easily by picking it up without any undue force.

The lid device may also include a control unit 170 coupled to the fingerprint sensor and the suction motor. The control unit can receive a fingerprint scan and verify the same with the pre-registered biometric data of a user. The control unit may include suitable memory to store the biometric data of the user. The control unit may also allow for registering the biometric data.

In certain implementations, the control unit can detect the placing of the disclosed device over a glass and can actuate the suction motor to create a partial vacuum in the glass for securing the lid device. For example, the user may tap the top plate of the device after placing the same over the glass. The device may also sense the contact of the device with the rim of the glass and activate the suction motor. Also, the device may include sensors 180, such as an accelerometer and gyroscope for sensing the placing gestures i.e., placing the device over the glass.

The device may also include an alarm and or LED light unit 190, such as a buzzer. The alarm/LED light unit can be coupled to the control unit. The control unit can detect any unregistered touch on the top plate, such as on the fingerprint sensor. The control unit upon sensing unauthorized touch on the fingerprint sensor can trigger the alarm and/or LED light. Also, the control unit may detect forceful removal of the lid device from the glass and can trigger the alarm and/or LED light to notify the nearby people. The device may also include a gyroscope or similar sensor to detect the movement of the glass. The device in secure mode upon detecting movement of the glass can trigger the alarm and/or LED light.

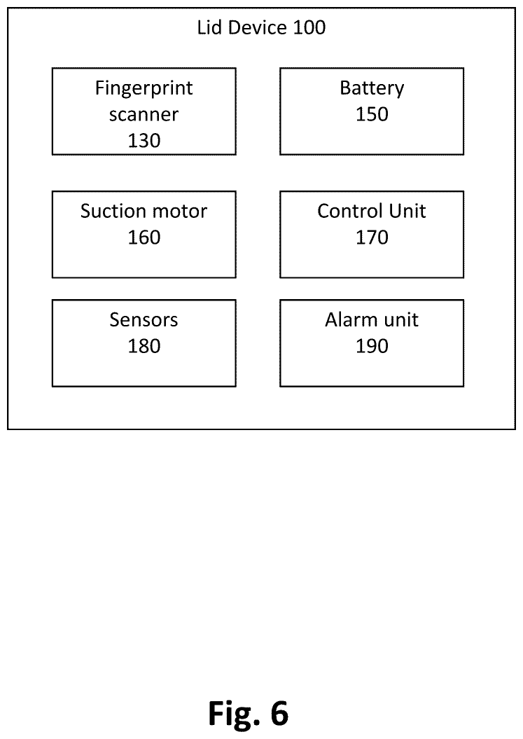

Referring to FIG. 6, which is a block diagram showing the architecture of the device. The device includes a fingerprint sensor 130, a battery 150, a control unit 170, an alarm unit 190, a suction motor 160, and sensors 180.

In certain implementations, the lid device can be secured to the glass using any mechanism other than suction, and any mechanism for securing the lid device to open the top of the glass is within the scope of the present invention. For example, the device lid can be secured like a conventional lid for covering a container. Examples of such securing mechanisms include snap fit, screwing the lid over the threaded top of the glass, and the like. The lid device can detect an authorized and unauthorized touch on the outer exposed surface of the lid device, and upon detecting unauthorized touch, the lid device can trigger the alarm.

In certain implementations, the disclosed lid device can merely cover the opening of the glass. The lid device can detect authorized and unauthorized touch on the outer exposed surface of the lid device, and upon detecting unauthorized touch, the lid device can trigger the alarm. For example, the alarm will be triggered with someone else tries to remove or lift the lid device from the glass.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A lid device for securely covering a glass, the lid device comprises:
a housing having a top plate, a bottom plate, and a side wall;
a fingerprint sensor mounted to the top plate;
a control unit encased within the housing;
a battery encased within the housing, the battery is configured to power at least the fingerprint sensor and the control unit,
wherein the lid device is configured to secure over the glass, wherein the control unit is configured to:
receive a fingerprint scan from the fingerprint sensor; and
upon verification of the fingerprint scan, allowing a release of the lid device from the glass.

2. The lid device of claim 1, wherein the lid device further comprises:
an alarm unit configured in the housing and operably coupled to the control unit, wherein the control unit is further configured to trigger the alarm unit upon recognizing a fingerprint scan that cannot be verified.

3. The lid device of claim 2, wherein the side wall of the housing comprises one or more steps made inwards from top to bottom, wherein a step of the one or more steps is configured to juxtapose over a rim of the glass.

4. A method for securely covering a glass, the method comprising:
providing a lid device comprising:
a housing having a top plate, a bottom plate, and a side wall,
a fingerprint sensor mounted to the top plate,
a control unit encased within the housing,
a battery encased within the housing, the battery is configured to power at least the fingerprint sensor and the control unit,
wherein the lid device is configured to secure over the glass, wherein the control unit is configured to:
receive a fingerprint scan from the fingerprint sensor; and
upon verification of the fingerprint scan, allowing a release of the lid device from the glass; and
placing the lid device over the glass, wherein the lid device securely fits over the glass.

5. The method of claim 4, wherein the lid device further comprises:
an alarm unit configured in the housing and operably coupled to the control unit, wherein the control unit is further configured to trigger the alarm unit upon recognizing a fingerprint scan that cannot be verified.

6. The method of claim 5, wherein the side wall of the housing comprises one or more steps made inwards from top to bottom, wherein a step of the one or more steps is configured to juxtapose over a rim of the glass.

7. The method of claim 5, wherein the method further comprises:
receiving the fingerprint scan from the fingerprint sensor;
verifying the fingerprint scan; and
upon verification, releasing the lid device from the glass, wherein the released lid device can be removed from the glass without any undue force.
